(19) United States
(12) Patent Application Publication
(10) Pub. No.: US 2025/0111232 A1
(43) Pub. Date: Apr. 3, 2025

(54) LARGE LANGUAGE MODEL (LLM) PRUNING USING EXTENDED KRONECKER APPROXIMATIONS

(71) Applicant: QUALCOMM Incorporated, San Diego, CA (US)

(72) Inventors: Tycho VAN DER OUDERAA, Amsterdam (NL); Markus NAGEL, Amsterdam (NL); Marinus Willem VAN BAALEN, Amsterdam (NL); Tijmen Pieter Frederik BLANKEVOORT, Amsterdam (NL)

(21) Appl. No.: 18/476,729

(22) Filed: Sep. 28, 2023

(51) Int. Cl. G06N 3/082

(52) U.S. Cl. CPC G06N 3/082

(57) ABSTRACT

An apparatus has one or more memories and one or more processor(s) coupled to the memories. The processor(s) is configured to estimate a local curvature of a loss landscape of a neural network. The processor(s) is also configured to dynamically allocate parameters to be removed from the neural network based on the local curvature. The processor(s) is further configured to update remaining weights of the neural network based on the parameters to be removed.

### FIELD OF THE DISCLOSURE

Aspects of the present disclosure generally relate to large language model (LLM) pruning using extended Kronecker approximations.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks. State-of-the-art language models are becoming increasingly large in efforts to achieve the highest performance on large corpora of available textual data. However, the sheer size of the used transformer architectures makes it increasingly difficult to deploy models within computational, environmental, or device-specific constraints.

### SUMMARY

Aspects of the present disclosure are directed to an apparatus. The apparatus has one or more memories and one or more processors coupled to the one or more memories. The processor(s) is configured to estimate a local curvature of a loss landscape of a neural network. The processor(s) is also configured to dynamically allocate parameters to be removed from the neural network based on the local curvature. The processor(s) is further configured to update remaining weights of the neural network based on the parameters to be removed.

In other aspects of the present disclosure, a processor-implemented method includes estimating a local curvature of a loss landscape of a neural network. The method also includes dynamically allocating parameters to be removed from the neural network based on the local curvature. The method further includes updating remaining weights of the neural network based on the parameters to be removed.

In other aspects of the present disclosure, a non-transitory computer-readable medium with program code recorded thereon is disclosed. The program code is executed by a processor and includes program code to estimate a local curvature of a loss landscape of a neural network. The program code also includes program code to dynamically allocate parameters to be removed from the neural network based on the local curvature. The program code further includes program code to update remaining weights of the neural network based on the parameters to be removed.

Other aspects of the present disclosure are directed to an apparatus. The apparatus includes means for estimating a local curvature of a loss landscape of a neural network. The apparatus also includes means for dynamically allocating parameters to be removed from the neural network based on the local curvature. The apparatus further includes means for updating remaining weights of the neural network based on the parameters to be removed.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIG. 5 is a diagram illustrating data-based compression, in accordance with various aspects of the present disclosure.

FIG. 6 is a diagram illustrating structured, semi-structured, and unstructured pruning, in accordance with various aspects of the present disclosure.

FIG. 7 is a flow diagram illustrating an example of a process for operating a neural network, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Aspects of the present disclosure introduce large language model (LLM) pruning techniques (referred to as Surgeon techniques) for unstructured, semi-structured, and structured compression of neural networks (e.g., LLMs). Although large language models are described, the techniques of the present disclosure also apply to multilayer perceptrons (MLPs) and neural networks. The techniques aim to find optimal pruning by expanding the curvature of the model loss landscape. The techniques utilize modern Fisher approximations to scale accurate pruning to the realm of large language models with millions or billions of parameters, while remaining practical for memory and compute resources. The techniques use weight strength and activations from forward passes, and also gradient information from backward passes to relate the expected cost of weight removal to the global final objective. Typically, model compression only occurs once in practice, after which it can be deployed many times at the achieved post-compression performance. This motivates the method which, compared to baseline techniques, takes more time to compress but achieves the most favorable performance/compression trade-off.

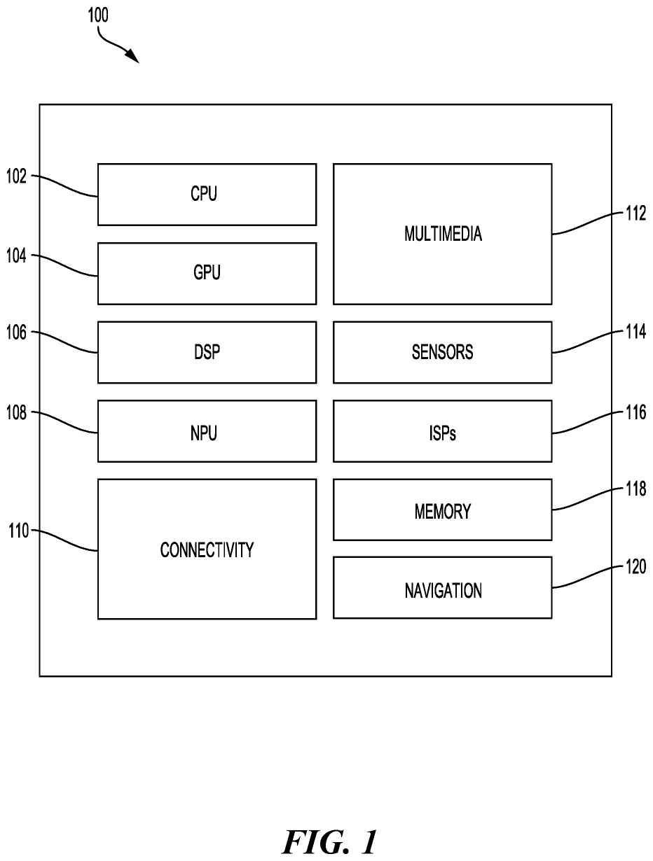

FIG. 1 illustrates an example implementation of a system-on-a-chip (SOC) 100, which may include a central processing unit (CPU) 102 or a multi-core CPU configured for pruning of artificial neural networks. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In aspects of the present disclosure, the instructions loaded into the general-purpose processor 102 may include code to estimate a local curvature of a loss landscape of a neural network. The general-purpose processor 102 may also include code to dynamically allocate parameters to be removed from the neural network based on the local curvature; and code to update remaining weights of the neural network based on the parameters to be removed.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

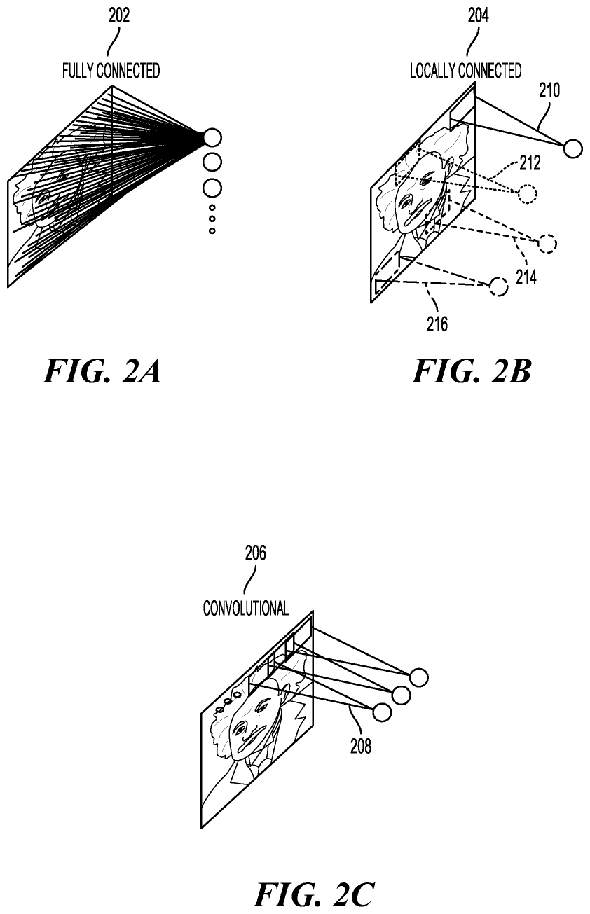

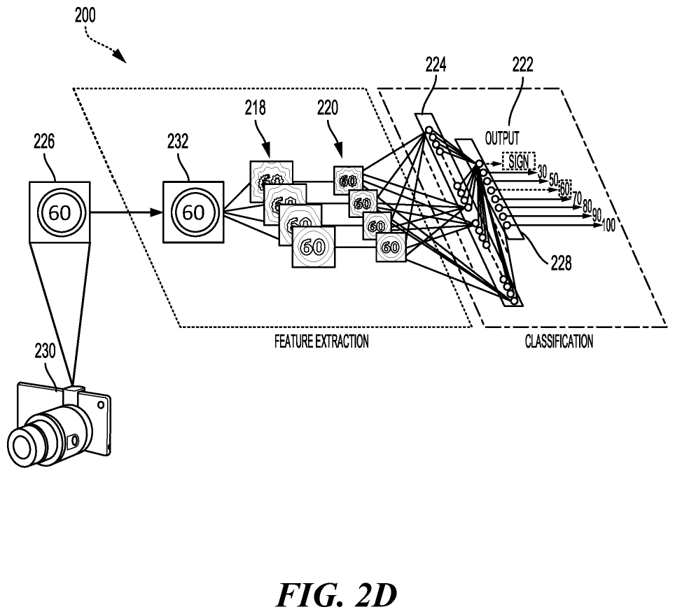

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

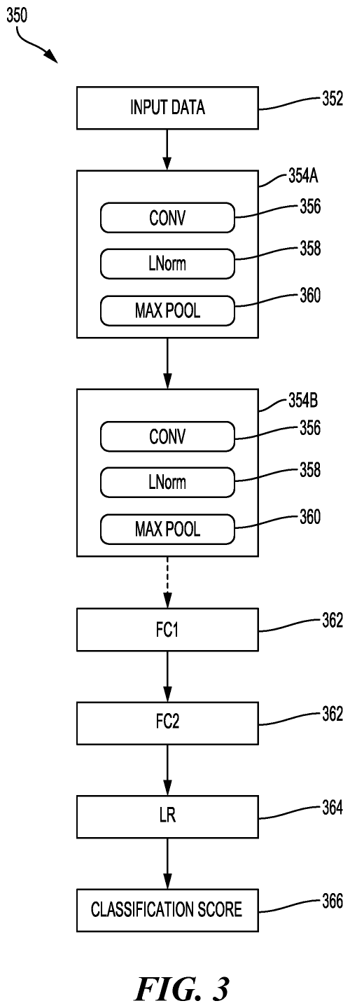

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

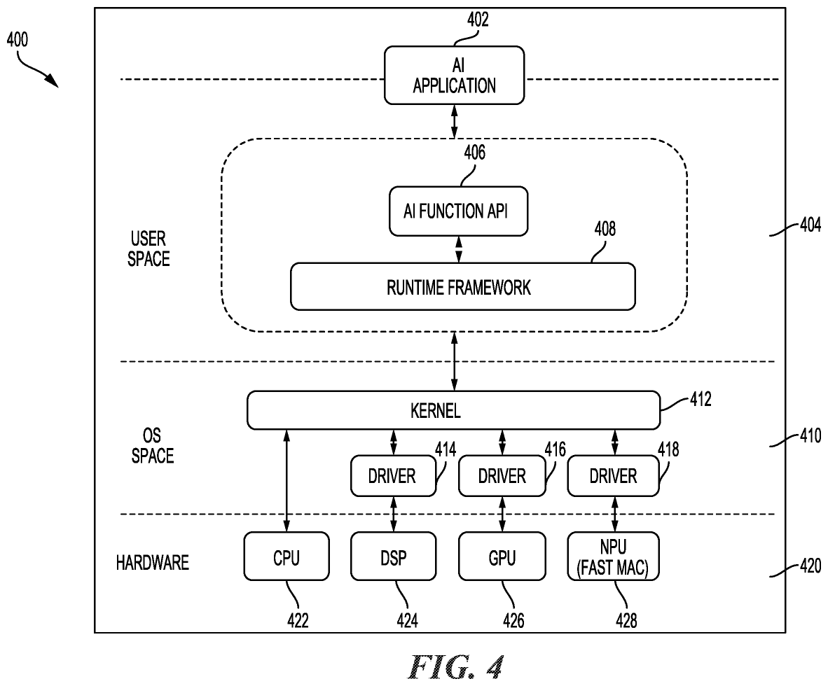

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SoC 100 of FIG. 1) to support pruning neural networks for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

State-of-the-art language models are becoming increasingly large in efforts to achieve the highest performance on large corpora of available textual data. However, the sheer size of transformer architectures makes it increasingly difficult to deploy models within computational, environmental, or device-specific constraints. Aspects of the present disclosure introduce data-driven compression of existing pretrained models as an alternative to training small models from scratch. To do so, scalable Kronecker-factored approximations of the local loss landscape curvature are improved, allowing dynamic allocation of structures that can be removed and updates of remaining weights. A general framework is provided for unstructured, semi-structured, and structured compression to improve upon existing estimates of the loss landscape, in order to better capture correlations between weights, while remaining computationally efficient.

Recent advancements in language modeling allow fitting large language models (LLMs) consisting of millions or billions of parameters on big text corpora achieving high performance. Unfortunately, the size of these LLMs may make it difficult to deploy them within practical constraints, such as limited memory for on-device inference or to reduce computational or memory requirements.

Data-based compression of existing large language models into smaller models is desired to meet deployment constraints, as an alternative to training new models from scratch. Some benefits of this learning paradigm are (i) leveraging the performance of existing pretrained LLMs without requiring large datasets or the need for expensive training, while at the same time (ii) obtaining a model that exactly fits deployment requirements, including environmental or hardware constraints.

Compared to conventional LLM pruning work, aspects of the present disclosure use more accurate approximations of the loss landscape curvature and account for more weight correlations when updating remaining weights. Unlike most prior data-based compression of LLMs, aspects of the present disclosure use weight strength and activations from forward passes, and also gradient information from backward passes to relate expected cost of weight removals to the final global objective, which allows for global thresholding. In addition, multi-shot procedures and first-order weight corrections are introduced to further improve compression performance.

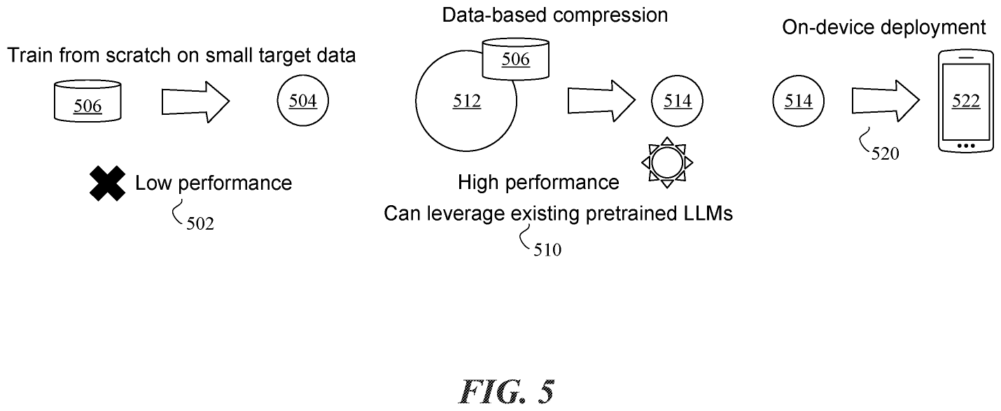

FIG. 5 is a diagram illustrating data-based compression, in accordance with various aspects of the present disclosure. In the leftmost section 502 of FIG. 5, a model 504 is trained from scratch on a small amount of target data 506, resulting in low performance. As seen in the center section 510 of FIG. 5, the target data 506 may train a large language model 512. Data-based surgery (also referred to as neural network pruning) of the pretrained large language model results in a compressed model 514. As seen in the rightmost section 520 of FIG. 5, the compressed model 514 may be deployed on a mobile device 522.

Neural network pruning aims to remove parameters from a model while minimizing negative impact on final performance. More formally, we denote the P parameters of an LLM as vector θ*=vec(W*₁, W*₂, . . . W*_{L})∈ [symbol] ^{P}, by flattening the L weight matrices of attention and fully-connected blocks, with already fitted θ*≈argmin_{θ} [symbol] (θ) to data [symbol] to minimize a negative likelihood loss [symbol] (θ)=−log p(θ| [symbol] ). A pruned vector \hat{θ} may be calculated to compress the model:

$$\hat{θ} = arg min ( θ ) ℒ ( θ ) s . t . pruning constraints based on {θ}^{*} , \qquad ( 1 )$$

where the selected constrains may influence (e.g., determine) the structure of compressed weights (and pruned vectors) \hat{θ}.

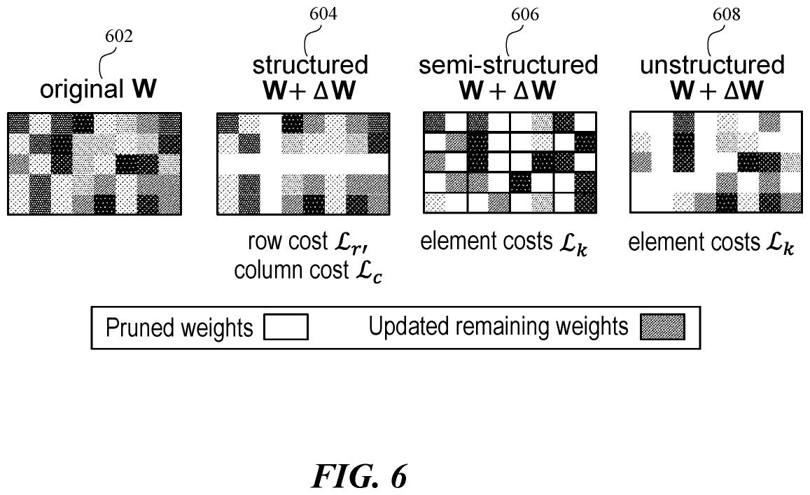

FIG. 6 is a diagram illustrating structured, semi-structured, and unstructured pruning, in accordance with various aspects of the present disclosure. An original weight matrix W (shown in the leftmost image 602) can be pruned in various manners. In structured pruning 604, entire rows and columns are set to zero. In semi-structured pruning 606 of M:N, M weights of every N consecutive weights are set zero. In the example of FIG. 6, one of every two weights is set to zero. In unstructured pruning 608, a fraction of total weight elements is set to zero. Structured pruning leads to the most immediate gains in memory and computing, as it directly reduces the dimensions of matrices that need to be represented explicitly, but is typically regarded as a more difficult compression task. In the other schemes, maintaining high performance is often easier, but requires specialized arithmetic that exploits the sparsity structure to benefit at deployment. All pruning types discussed above are considered with the LLM surgeon, with a focus on structured pruning for LLMs.

Typically, equation 1 cannot be solved directly, as the space of possible pruning configurations exceeds what can be evaluated in practice. To illustrate, a search over all possible unstructured pruning masks of a 125 million parameter LLM would require 2^{P}=2^{125m}≈10³⁷⁶²⁸⁷⁴⁹ evaluations. The idea, therefore, is to introduce a surrogate model q of the loss landscape that is easier to process:

$$ℒ ( θ ) = - log p ( θ \vert 𝒟 ) \approx - log q ( θ ) , \qquad ( 2 )$$

and use the surrogate model q to find pruned solutions \hat{θ} to equation 1. If one chooses a particular Gaussian form for the surrogate q, then solutions for unstructured, semi-structured, and structured pruning constraints can be derived in closed-form, as described in detail below in Appendix A.

Taylor expansion is now described for obtaining a good surrogate of the loss q. One approach is to locally expand the log loss through a second-order Taylor expansion around the pretrained weights \hat{θ}, yielding:

$$- log q ( θ ) \approx - log p ( {θ}^{*} \vert 𝒟 ) - {( θ - {θ}^{*} )}^{T} ∇ ℒ ( {θ}^{*} ) - \frac{1}{2} {( θ - {θ}^{*} )}^{T} {H}_{{θ}^{*}} ( θ - {θ}^{*} ) , \qquad ( 3 )$$

$${where [ ∇ ℒ ( {θ}^{*} ) ]}_{i} = \frac{\partial }{\partial {θ}_{i}} ℒ ( {θ}_{i}^{*} )$$

denotes the Jacobian and

$${[ {H}_{θ} ]}_{i j} = \frac{{\partial }^{2}}{\partial {θ}_{i} {θ}_{j}} ℒ ( {θ}_{i j} )$$

denotes the Hessian. The first-order term vanishes [∇ [symbol] (θ*)]ᵢ=0 at the optimum. This is an oversimplification, because (i) the neural network may not be optimized to the minimum, (ii) we may use a different loss for compression than was used to train the network, (iii) we prune in multiple shots inevitably causing weights to diverge from the optimum. Nevertheless, we initially follow this simplifying assumption and consider interleaved first-order corrections to mitigate the issue. The quadratic expansion of equation 3 forms the basis of the optimal brain damage and optimal brain surgeon pruning methods, described below in Appendix A. From a probabilistic perspective, a quadratic approximation of the log likelihood implies a Gaussian approximation of the likelihood. This is well-known as the Laplace approximation q(θ)= [symbol] (θ|θ*+∇ [symbol] (θ*), H_{θ*}⁻¹) with pretrained weights as the mean and the local inverse Hessian is the covariance matrix capturing correlations between weights.

One way to approximate the Hessian is through the Fisher Information Matrix:

$${H}_{θ} \approx {F}_{θ} = {\sum }_{n = 1}^{N} {𝔼}_{y \sim {p}_{θ} ( y \vert {x}_{n} )} [ {∇}_{θ} log {p}_{θ} ( y \vert {x}_{n} ) {∇}_{θ} log {{p}_{θ} ( y \vert {x}_{n} )}^{T} ] , \qquad ( 4 )$$

which has the benefit of always being positive semi-definite, with the inverse thus forming a proper covariance matrix for q, and can be approximated with Monte Carlo samples of p_{θ}(y|xₙ). For most LLMs, we simply treat the softmax output of the network as categorical distribution p_{θ}(y|xₙ), and sample from that. The full Fisher F_{θ}∈ [symbol] ^{P×P} scales quadratically in the number of parameters P. To overcome this, the Fisher is often written in terms of layer-wise blocks Fₗₖ=Σₙ₌₁^{N} [symbol] [vec(∇_{W}_{ₗ} log p_{θ}(y|xₙ))vec(∇_{W}_{ₖ} log p_{θ}(y|xₙ))^{T}], and approximated by only considering block-diagonal components of each layer:

$${F}_{θ} = diag ( {F}_{11} , {F}_{22} , … , {F}_{L L} ) , {F}_{l} = {\sum }_{n = 1}^{N} 𝔼 [ {\underbrace{( {g}_{l , n} {g}_{l , n}^{T} ) ⊗ ( {a}_{l , n} {a}_{l , n}^{T} )}}_{RC \times RC} ] , \qquad ( 5 )$$

where ⊗ denotes the Kronecker product. Because cross-layer interactions may be disregarded, Fₗ may be used instead of Fₗₗ for Fisher blocks associated with a weight matrix Wₗ∈ [symbol] ^{R×C} producing outputs y_{l,i}=Wₗa_{l,i}∈ [symbol] ^{R} from inputs a_{l,i}∈ [symbol] ^{C}, where l denotes the layer and i the datapoint. Consequently, the Fisher blocks may be written in terms of input activations a_{l,n}∈ [symbol] ^{C} obtained by forward passing data xᵢ and associated output gradients g_{l,i}=∇_{y}_{_{l,i}} [symbol] ∈ [symbol] ^{R} from backpropagation.

Pruning as constrained optimization is now discussed. From the Gaussian approximation p≈q= [symbol] (θ*, F⁻¹) obtained by quadratically expanding the log likelihood

$$loss - log p \approx \frac{1}{2} {θ}^{T} F θ ,$$

the optimal update Δθ=\hat{θ}−θ (and thus also \hat{θ}=θ+Δθ) becomes the following equality constrained quadratic optimization problem:

$${Arg min}_{Δ θ} \frac{1}{2} Δ {θ}^{T} F Δ θ s . t . {e}_{k}^{T} Δ θ + {e}_{k}^{T} θ = 0 , ∀ k ϵ𝒦 \qquad ( 6 )$$

where F is positive semi-definite and [symbol] is the set of K indices that are pruned (e.g., set to zero).

We denote E_{K}=[eₖ_{₁} eₖ_{₂} . . . e_{q}_{ₖ}]^{T}∈[0,1]^{Q×P} as a matrix of which the row vectors are canonical basis vectors eₖ that select the elements to be pruned. One of the most standard approaches to solve equation 6 is using Lagrange multipliers, which results in a general closed-form solution for the expected increase in loss [symbol] and optimal weight update Δθ:

$$ℒ = \frac{1}{2} {( {E}_{K} {θ}^{*} )}^{T} {( {E}_{K} {F}^{- 1} {E}_{K}^{T} )}^{- 1} {E}_{K} θ , \qquad ( 7 )$$

$$Δθ = - {F}^{- 1} {{E}_{K}^{T} ( {E}_{K} {F}^{- 1} {E}_{K}^{T} )}^{- 1} {E}_{K} θ , \qquad ( 8 )$$

which may be used to derive all unstructured, semi-structured, and structured pruning, in conjunction for modern Fisher approximations. The same general form of equations 7 and 8 appear in prior work on LLM pruning, but like SparseGPT, uses a much simpler layer-wise Fisher approximation that ignores gradient information and does not consider structured pruning.

Process 1 LLM-Surgeon (Structured)

```
Input: initial weights θ₀ target size α, and data [symbol]
  For shot t in [1, 2, ..., T]
    Compute: approximate curvature G, A from data [symbol]
    Compute: costs per row/column [symbol]    ᵣ, [symbol]    _{c} from G, A
    Compute: threshold τ using [symbol]    ᵣ and [symbol]    _{c} given target size α
    Select: rows and columns to remove K_{R}, K_{c} based on τ
    Compute: weight update Δθ^{t-1} based on K_{R}, K_{c} and G, A
    Update: remaining weights θ^{t} ← θ^{t-1} + Δθ^{t-1}
    Optionally: θ^{t} ← low-rank update(θ^{t})
  Output: compressed weights \hat{θ} = θ^{T}
```

### LLM Surgeon

The components of the technique, referred to as LLM Surgeon, are summarized in the pseudocode shown for process 1. Computing the approximate curvature is first described. Even when considering only block-wise approximation of the Fisher F∈ [symbol] ^{RC×RC} of equation 5, individual blocks remain a sum of N large RC×RC matrices, too large to practically fit in memory, where RC represents the row and column. Instead, we adapt the classical Kronecker solution (e.g., Kronecker-factored approximate curvature (KFAC)) that assumes independence of activations and derivatives (IAD) to approximate Fisher blocks Fₗ≈\tilde{F}ₗ as single Kronecker products:

$$\tilde{{F}_{l}} = {G}_{l} ⊗ {A}_{l} , with \qquad ( 9 )$$

$${G}_{l} = \frac{1}{\sqrt{N}} {\sum }_{n = 1}^{N} {g}_{l , n} {g}_{l , n}^{T} and {A}_{l} = \frac{1}{\sqrt{N}} {\sum }_{n = 1}^{N} {a}_{l , n} {a}_{l , n}^{T}$$

constructed from activations a_{l,n}∈ [symbol] ^{C} from forward passes and gradients g_{l,n}∈ [symbol] ^{R} from backward passes.

An additional advantage of approximating Fisher blocks as Kronecker products is that the inverse becomes particularly easy to compute \tilde{F}⁻¹=G⁻¹⊗A⁻¹, only requiring inverting the factors. This fact allows us to avoid explicitly constructing large RC×RC matrices in memory that make up \tilde{F} and \tilde{F}⁻¹, and instead directly work with the much smaller matrices G and A.

Computing costs in final loss (costs per row/column) is now described. The number of possible combinations in which weights can be removed grows exponentially in parameter count, making it infeasible to estimate a separate cost [symbol] for each such removal. A strategy, therefore, is to treat weights independently when computing removal costs [symbol] . Still, this does not necessarily imply that the same strong independence assumption is made for the weight updates Δθ after selecting weights to be removed. Unlike most conventional systems, correlated weight updates are presented by taking into account off-diagonal elements of the Fisher approximation.

For semi-structured and unstructured pruning, independent costs for individual weight elements k∈[1, RC] may be used, and for structured pruning independent costs for all rows r∈[1, R] and columns c∈[1, C] may be used. The appropriate costs from the general cost formula equation 7 may be derived by letting E=eₖ∈ [symbol] ^{RC}, where the single one-hot element at index k of canonical basis vector eₖ selects the weight to remove. For structured pruning, rows r and columns c may be selected by setting E=eᵣ^{T}⊗I∈ [symbol] ^{C×RC} or E=I⊗e_{c}∈ [symbol] ^{R×RC} with eᵣ∈ [symbol] ^{R}, e_{c}∈ [symbol] ^{C}. Plugging into equation 7:

$${ℒ}_{k} = \frac{1}{2} \frac{{( {θ}_{k} )}^{2}}{{[ {G}^{- 1} ⊗ {A}^{- 1} ]}_{kk}} , {ℒ}_{r} = \frac{1}{2} \frac{{θ}_{r}^{T} A {θ}_{r}}{{[ {G}^{- 1} ]}_{rr}} , {ℒ}_{c} = \frac{1}{2} \frac{{θ}_{c}^{T} G {θ}_{c}}{{[ {A}^{- 1} ]}_{cc}} \qquad ( 10 )$$

Full derivations can be found below in Appendix A. The costs for single elements [symbol] ₖ are equivalent to those found in optimal brain surgeon and [symbol] ᵣ and [symbol] _{c} closely resemble structured brain surgeon, but in our case derived for matrix rows and columns (see Appendix A—removing a single row or column). Given curvature estimates, costs for both elements or rows and columns can be computed in parallel. In addition, costs for the more general sum of Kronecker factor approximation \tilde{F}≈G₁⊗A₁+G₂⊗A₂ may be derived in Appendix C through an eigendecomposition.

Dynamic weight allocation with a global threshold pertains to computing the threshold and selecting rows and columns to remove in process 1. Unlike prior works that compress layer-by-layer, we use a global threshold τ, enabling a dynamic allocation of sparsity levels across layers, pruning most where impact is the least. The proposed compression method can compress a model to a specifically chosen target size α, defined as the fraction of weights that should remain, e.g., stay non-zero after compression. In all structured, semi-structured, and unstructured pruning, we select as many weights for removal so that the target size a is reached with the least possible costs [symbol] , as computed according to the computing costs in final loss, as described above. For unstructured pruning, this includes sorting the costs for all weights [symbol] ₖ in the network and setting a global threshold τ such that the α fraction of weights fall within the threshold [symbol] ₖ≤τ. For M:N semi-structured pruning, the M costs of each N consecutive weights may be sorted and the M weights with lowest cost may be selected. In case of a multi-shot schedule (see below), the costs of those M lowest costs may be summed in each block to find a cost per block, sort costs per block across the entire network, and similar to the unstructured case set a global threshold τ such that an α fraction of weights fall within the threshold. Lastly for structured pruning, a sorting may be performed, the sorting may be appropriately weighted by the number of elements that make up a row or column and set the global threshold τ such that the α fraction of all weights falls within the threshold. Then, all rows and columns that fall within the threshold [symbol] ᵣ, [symbol] _{c}≤τ may be removed.

Correlated weight updates relate to computing weight updates in process 1. For weight updates Δθ, we do not make the same simplifying independence assumption as during cost computation [symbol] , unlike most prior work. That is, we assume rows, columns, or weights are independent when computing expected costs, to circumvent the need to compute costs for each possible combination in which weights could be removed, which would quickly become unwieldy. However, as soon as we have selected the set of weights for pruning, we can often afford to compute a single correlated weight update associated to the joint removal of multiple weights, instead of naively summing weight updates associated to individual removals. We derive such correlated weight updates.

For fast unstructured and semi-structured correlated weight updates, mathematically, we represent pruned weights as E_{K}=[e₁ e₂ . . . e_{R′}]^{T}∈ [symbol] ^{K×RS}, where eᵣ∈ [symbol] ^{R′} are one-hot canonical basis vectors selecting the weights for removal. As each element k has a unique associated row r and column c index, we can consequently also use canonical basis vectors for these respective rows E_{R}∈ [symbol] ^{K×R} and columns E_{C}∈ [symbol] ^{K×C} (e.g., we have [E_{R}]ᵢ⊗[E_{C}]ᵢ=[E_{K}]ᵢ is satisfied for all i).

We derive unstructured weight updates in Appendix A (removing a single element) by considering eigen decompositions G=K₁S₁K₁^{T}, A=K₂S₂K₂ of the Fisher approximation F≈G⊗A, which from equation 8 yields:

$$Δ W = {G}^{- 1} ( {{K}_{1} ( {\underbrace{\overline{\frac{{K}_{1}^{T} {W}^{- 1} {K}_{2}}{S}}}}_{K \times K} )}^{- 1} {K}_{2} ) {A}^{- 1} \qquad ( 11 )$$

where for brevity bar notation K̅₁=E_{K}K₁, K̅₂=E_{K}K₂, θ̅=E_{K}θ, and S=diag(S₁)diag(S₂)^{T}∈ [symbol] ^{R×C}, and diag(⋅) vectorizes matrix diagonals.

Programmatically, we always avoid explicitly representing large matrices \tilde{F} and \tilde{F}⁻¹ in memory, but rather compute relevant quantities from their factors. Likewise, we never represent sparse matrices E_{K}, E_{R} or E_{C} in memory, but instead work with a list of indices of the one-hot elements directly. For example, K̅₁=E_{R}K₁∈ [symbol] ^{K×R} and K̅₂=E_{C}K₂∈ [symbol] ^{K×C} may be constructed by copying row vectors, and the vector θ̅=E_{K}θ=E_{R}WE_{C}^{T}∈ [symbol] ^{K} by indexing all pruned weights.

For a maximum number of correlated weights, the main computational bottleneck is the K×K matrix inverse in equation 11. To control compression speed, we can split pruned weights into disjoint subsets K=K₁∪K₂∪, such that each subset Kᵢ does not exceed the set maximum number of correlated weights Kᵢ≤m, and sum associated independent updates. Using less correlation by setting a lower m allows trading compression quality for speed.

For fast structured correlated weight updates, unlike the general case, which requires inverting a K×K matrix for K correlated weights, weight updates with the Kronecker factored Fisher approximation \tilde{F}=G⊗A only requires inverting a R′×R′ matrix when removing R′ rows or a C′×C′ matrix when removing C′ columns. The updates use fewer resources (e.g., are cheaper) than expected based on the effective number of weights in those rows and columns, which would imply inverting R′C×R′C or RC′×RC′ matrices. In practice, this leads to a significant speed-up for structured pruning and weight updates that take into account correlations between rows or columns. When removing R′ rows, r₁, r₂, . . . r_{R′}, or the C′ columns, c₁, c₂, . . . c_{C′}, with 1<R′<R and 1<C′<C, we denote one-hot vectors selecting all rows and columns to be removed respectively as E_{R′}=[e₁ e₂ . . . e_{R′}]^{T}∈ [symbol] ^{R′×R} and E_{C′}=[e₁ e₂ . . . e_{C′}]^{T}∈ [symbol] ^{C′×C}. Weight updates associated with removing the R′ rows may be determined by setting E_{K}=E_{R′}⊗I or E_{K}=I⊗E_{C′}:

$$remove multiple {R}^{′} rows : Δ W = - {\overline{W} ( {E}_{{C}^{′}} {A}^{- 1} {E}_{{C}^{′}}^{T} )}^{- 1} ( {A}^{- 1} {E}_{{C}^{′}}^{T} ) \\ remove multiple {C}^{′} columns : Δ W = - {G}^{- 1} {{E}_{{R}^{′}}^{T} ( {E}_{{R}^{′}} {G}^{- 1} {E}_{{R}^{′}}^{T} )}^{- 1} \overline{W} \qquad ( 12 )$$

From here, the special case of removing a single row r or column c under Kronecker approximation involves inverting a 1×1 matrix, and thus only requires scalar division:

$$remove single row r : Δθ = - \frac{{G}^{- 1} {e}_{r} ⊗ {θ}_{r}}{{[ {G}^{- 1} ]}_{rr}} , \\ or single column c : Δθ = - \frac{{θ}_{c} ⊗ {A}^{- 1} {e}_{c}}{{[ {A}^{- 1} ]}_{cc}} , \qquad ( 13 )$$

in accordance with independent structured updates for convolutional filters. We have thus extended existing structured weight updates to rows and columns, and derived update rules that also consider correlation between structured groups (e.g., the rows and columns).

A multi-shot pruning schedule relates to the update of remaining weights in process 1. Aspects of the present disclosure allow compression to a specific target size α, defined as the fraction of weights remaining after pruning, e.g., (1-α)P of the P total model parameters are set to zero. The surrogate loss landscape q relies on a Taylor expansion (equation 3), which only holds locally, and thus becomes unreliable for larger jumps Δθ in parameter space. We mitigate this by pruning in multiple shots s E [1, 2, . . . , S], each with smaller updates Δθ and re-estimating the loss surfaces afterwards. Multi-shot pruning enables more computation (linearly in S) to improve the final compression performance. Because a model only needs to be compressed once, after which it can be used many times for deployment, being able to spend additional compute resources to improve final compression performance is a desirable property. Performance monotonically improves with more shots and higher sparsity levels typically require more shots.

The optional step in process 1 is now described with respect to interleaved low-rank first-order corrections. So far, we assumed that the model is at an optimum to find a closed-form solution to the quadratic constraint problem. In practice, however, this assumption likely does not hold for several reasons discussed above. To mitigate this, we consider first-order corrections by interleaving pruning shots with low-rank adaptations of weights Wₗ+UV, commonly used in large language modeling. We absorb updates after each shot, meaning that the next loss curvature estimate q will be closer to the optimum and the assumptions underlying the quadratic expansion are likely to hold more closely. By absorbing low-rank adaptation (LoRA) of LLMs updates between shots, the sum of low-rank updates can have a higher rank than individual updates. That is, rank (U¹V¹+U²V²+ . . . +U^{S}V^{S})≥rank(U^{S}V^{S}) for any update s, with equality only arising if updates lie exactly in the same subspace, which is unlikely to occur in practice. This insight could also be used during regular LoRA fine tuning and therefore has applications outside the context of model compression to allow more expressive low-rank model adaptation, at negligible cost.

In the present disclosure, we have introduced the LLM surgeon technique for unstructured, semi-structured, and structured compression of neural networks. The work aims to find optimal pruning by expanding the curvature of the model loss landscape. The method utilizes modern Fisher approximations to scale accurate pruning to the realm of large language models with millions or billions of parameters, while remaining practical in memory and compute resources. Unlike most prior work on data-based LLM compression, we not only use weight strength and activations from forward passes, but also use gradient information from backward passes to relate the expected cost of weight removal to the global final objective. Compared to prior work, the method uses a more accurate approximation of the loss landscape curvature and takes more weight correlations into account when updating remaining weights, while staying efficient on modern hardware. Typically, model compression only occurs once in practice, after which it can be deployed many times at the achieved post-compression performance. This motivates our method which, compared to baselines, takes more time to compress but achieves the most favorable performance/compression trade-off.

### APPENDIX A

Given that we use a Gaussian approximation of our loss p≈q= [symbol] through a quadratic approximation of our log

$$likelihood - log p \approx \frac{1}{2} {( {θ}^{*} )}^{T} F {θ}^{*} ,$$

the most optimal compression becomes the solution to the following constrained optimization problem:

$${arg min}_{{Δθ}^{*}} \frac{1}{2} {Δ ( {θ}^{*} )}^{T} F {Δθ}^{*} s . t . {e}_{k}^{T} Δ {θ}^{*} + {e}_{k}^{T} {θ}^{*} = 0 , ∀ k ϵ Q \qquad ( 14 )$$

where Q is the set of Q indices that are pruned.

A general solution is now discussed.

In some examples, pruned elements may be denoted as E_{K}=[e_{q1} e_{q2} . . . ]^{T}∈[0,1]^{|Q|×P} and the fact that solving equation 6 through use of Lagrange multipliers gives the general closed-form solution for cost [symbol] and weight update Δθ:

$$ℒ = \frac{1}{2} {( {E}_{K} {θ}^{*} )}^{T} {( {E}_{K} {F}^{- 1} {E}_{K}^{T} )}^{- 1} {E}_{K} {θ}^{*} \qquad ( 15 )$$

$${Δθ}^{*} = {F}^{- 1} {{E}_{K}^{T} ( {E}_{K} {F}^{- 1} {E}_{K}^{T} )}^{- 1} {E}_{K} {θ}^{*} \qquad ( 16 )$$

Removing a single element is now discussed.

Optimal brain surgeon (OBS): To remove a single element with index q, we simply set E_{K}=eₖ^{T}:

$$\begin{matrix}ℒ = \frac{1}{2} {( {E}_{K} {θ}^{*} )}^{T} {( {E}_{K} {F}^{- 1} {E}_{K}^{T} )}^{- 1} {E}_{K} θ \\ = \frac{1}{2} {θ}_{k}^{T} \frac{1}{{[ {F}^{- 1} ]}_{kk}} {θ}_{k} \\ = \frac{1}{2} \frac{{( {θ}_{k} )}^{2}}{{[ {F}^{- 1} ]}_{kk}}\end{matrix} , \begin{matrix}Δ θ = - {F}^{- 1} {{E}_{K}^{T} ( {E}_{K} {F}^{- 1} {E}_{K}^{T} )}^{- 1} {E}_{K} θ \\ = - {F}^{- 1} {{e}_{k} ( {e}_{k}^{T} {F}^{- 1} {e}_{k} )}^{- 1} {e}_{K}^{T} θ \\ = - \frac{{θ}_{k}}{{[ {F}^{- 1} ]}_{kk}} {F}^{- 1} {e}_{k}\end{matrix} \qquad ( 17 )$$

which exactly corresponds to the loss and updates of optimal brain surgeon.

Optimal brain damage (OBD): We may also consider that elements are independent and the Fisher is diagonal. After noting that this implies that diagonal elements of the inverse Fisher are scalar inverses of elements in the Fisher

$${[ {F}^{- 1} ]}_{kk} = \frac{1}{{[ F ]}_{kk}} ,$$

the formulas simplify to:

$$ℒ = {[ F ]}_{kk} {( {θ}_{k} )}^{2} , Δθ = - {θ}_{k} {e}_{k} , \qquad ( 18 )$$

which exactly corresponds to loss and updates of optimal brain damage.

Vectorized.

For implementation purposes, it might be convenient to have a vectorized notation [symbol] _{θ}∈ [symbol] ^{RC} or [symbol] ∈ [symbol] ^{R×C} to calculate all expected losses in parallel:

$$For OBD : {ℒ}_{θ} = \frac{1}{2} {θ}^{*} ⊙ {θ}^{*} ⊙ diag ( F ) \\ {ℒ}_{𝒲} = \frac{1}{2} {W}^{*} ⊙ {W}^{*} ⊙ mat ( diag ( F ) ) \\ For OBS : {ℒ}_{θ} = \frac{1}{2} {θ}^{*} ⊙ {θ}^{*} diag ( {F}^{- 1} ) \\ {ℒ}_{𝒲} = \frac{1}{2} {W}^{*} ⊙ {W}^{*} mat ( diag ( {F}^{- 1} ) ) \qquad ( 19 )$$

Removing a single row or column.

Structured OBS: If we consider the approximation F≈G⊗A with known inverse (G⊗A)⁻¹=G⁻¹⊗A⁻¹, then to remove a row at index r∈[0, R], we take into account correlations within elements of that row. That is, we write matrix E_{K}=(eᵣ^{T}⊗I) containing one-hot row-vectors for all elements in row r. Plugging into the general solution equation 7, we find:

$$\begin{matrix}ℒ = \frac{1}{2} {E}_{K} {{θ}^{T} ( {E}_{K} {F}^{- 1} {E}_{K}^{T} )}^{- 1} {E}_{K} {θ}^{*} \\ = \frac{1}{2} {( ( {e}_{r}^{T} ⊗ I ) {θ}^{*} )}^{T} {( ( {e}_{r}^{T} ⊗ I ) {( G ⊗ A )}^{- 1} {( {e}_{r}^{T} ⊗ I )}^{T} )}^{- 1} ( {e}_{r}^{T} ⊗ I ) {θ}^{*} \\ = \frac{1}{2} {{θ}_{r}^{T} ( {e}_{r}^{T} {G}^{- 1} {e}_{r} ⊗ {IA}^{- 1} I )}^{- 1} {θ}_{r} \\ = \frac{1}{2} {θ}^{T} ( {e}_{r}^{T} ⊗ I ) {( [ {[ {G}^{- 1} ]}_{rr} ] ⊗ {A}^{- 1} )}^{- 1} ( {e}_{r} ⊗ I ) {θ}_{r} \\ = \frac{1}{2} \frac{{θ}_{r}^{T} A {θ}_{r}}{{[ {G}^{- 1} ]}_{rr}}\end{matrix} \qquad ( 20 )$$

where we write θᵣ=eᵣ^{T}W*∈ [symbol] ^{C} for the r'th row-vector in W. Similarly, we obtain the associated weight update:

$$\begin{matrix}Δθ = - {F}^{- 1} {{E}_{K}^{T} ( {E}_{K} {F}^{- 1} {E}_{K}^{T} )}^{- 1} {E}_{K} a {θ}^{*} \\ = - {( G ⊗ A )}^{- 1} {( {e}_{r}^{T} ⊗ I )}^{T} {( ( {e}_{r}^{T} ⊗ I ) {( G ⊗ A )}^{- 1} {( {e}_{r}^{T} ⊗ I )}^{T} )}^{- 1} ( {e}_{r}^{T} ⊗ I ) {θ}^{*} \\ = - ( {G}^{- 1} ⊗ {A}^{- 1} ) ( {e}_{r} ⊗ I ) {( {e}_{r}^{T} {G}^{- 1} {e}_{r} ⊗ {A}^{- 1} )}^{- 1} {θ}_{r} \\ = - \frac{1}{{[ {G}^{- 1} ]}_{rr}} ( {G}^{- 1} {e}_{r} ⊗ {A}^{- 1} {IA}^{- 1} I ) {θ}_{r} \\ = - \frac{{G}^{- 1} {e}_{r} ⊗ {θ}_{r}}{{[ {G}^{- 1} ]}_{rr}}\end{matrix} \qquad ( 21 )$$

arriving at a similar structured pruning update for convolutional filters. We can equivalently derive expected loss and update for columns, by considering E_{K}=(I⊗e_{c}^{T}). If we do so, we find the structured updates for a row r or column c:

$$Remove row r : \begin{matrix}ℒ = \frac{1}{2} \frac{{θ}_{r}^{T} A {θ}_{r}}{{[ {G}^{- 1} ]}_{rr}} & Δθ = - \frac{{G}^{- 1} {e}_{r} ⊗ {θ}_{r}}{{[ {G}^{- 1} ]}_{rr}}\end{matrix} \\ Remove column c : \begin{matrix}ℒ = \frac{1}{2} \frac{{θ}_{c}^{T} G {θ}_{c}}{{[ {A}^{- 1} ]}_{cc}} & Δθ = - \frac{{θ}_{c} ⊗ {A}^{- 1} {e}_{c}}{{[ {A}^{- 1} ]}_{cc}}\end{matrix} \qquad ( 22 )$$

Structured OBD: We may also assume that, when removing a row r, the individual elements within the row are also independent which would imply

$${[ A ]}_{ii} = \frac{1}{{[ {A}^{- 1} ]}_{ii}} .$$

### Similarly,

$${[ G ]}_{i i} = \frac{1}{{[ {G}^{- 1} ]}_{i i}}$$

when removing a column c. Consequently, we can simplify to:

$$\begin{matrix}Remove row r : & ℒ = \frac{1}{2} {G}_{rr} {θ}_{r}^{T} A {θ}_{r} & Δθ = - {e}_{r} {θ}_{r}^{T} \\ Remove column c : & ℒ = \frac{1}{2} {A}_{c c} {θ}_{c}^{T} G {θ}_{c} & Δθ = - {θ}_{c} {e}_{c}^{T} ,\end{matrix} \qquad ( 23 )$$

which is a similar form to structured OBD losses and updates for convolutional filters. Equation 23 pertains to removal of a single row. The derivations slightly differ in that we start from the general solution equation 8, circumventing the need to rederive Lagrange multipliers for each possible structure.

Pruning multiple (correlated) rows and columns.

Let us consider the removal of R′ rows r₁, r₂, . . . r′_{R} rows or C′ columns with indices c₁, c₂, . . . , c_{C′}, with 1<R′<R and 1<C′<C. We denote matrices containing one-hot vectors selecting all rows and columns to be removed respectively as:

$${E}_{{R}^{′}} = \begin{matrix}[ {e}_{1} & {e}_{2} & … & {{e}_{{R}^{′}} ]}^{T}\end{matrix} ∈ {ℝ}^{{R}^{′} \times R} {E}_{{C}^{′}} = \begin{matrix}[ {e}_{1} & {e}_{2} & … & {{e}_{{C}^{′}} ]}^{T}\end{matrix} ∈ {ℝ}^{{C}^{′} \times C} \qquad ( 24 )$$

Then, the matrix E_{K} containing one-hot row vectors selecting all elements to be removed can be written as:

$$\begin{matrix}Multiple rows : {E}_{K} = ( {E}_{{R}^{′}} ⊗ {I}_{C} ) ∈ {ℝ}^{Q \times R C} , ( with Q = {R}^{′} C ) \\ Multiple columns : {E}_{K} = ( {I}_{R} ⊗ {E}_{{C}^{′}} ) ∈ {ℝ}^{Q \times R C} , ( with Q = {RC}^{′} )\end{matrix} \qquad ( 25 )$$

To simultaneously remove rows and columns, we can stack the matrices with duplicate row vectors removed:

$$Multiple rows and columns : {E}_{K} [ \begin{matrix}{E}_{{R}^{′}} ⊗ & {I}_{C} \\ {I}_{R} ⊗ & {E}_{{C}^{′}}\end{matrix} ] {R}^{Q \times RC} \qquad ( 26 )$$

The removal of duplicate rows is required due to the few R′C′ overlapping elements between rows and columns, after which the total number of rows becomes Q=R′C+C′R−R′C′. We use appropriately sized identity matrices I_{R}∈ [symbol] ^{R×R} and I_{C}∈ [symbol] ^{C×C}. For brevity, we write the vector or matrix of pruned weights θ̅:=E_{K}θ∈ [symbol] ^{Q}.

First, we derive the removal for R′ rows by defining removal matrix as E_{K}=E_{R′}⊗I and define W̅:=E_{R′}\mW∈ [symbol] ^{R′×C}. The complete weight update for the removal of multiple rows becomes:

$$\begin{matrix}Δθ = - {F}^{- 1} {{E}_{K}^{T} ( {E}_{K} {F}^{- 1} {E}_{K}^{T} )}^{- 1} {E}_{K} {θ}^{*} \\ = - {( G ⊗ A )}^{- 1} {( {E}_{{R}^{′}} ⊗ I )}^{T} {( ( {E}_{{R}^{′}} ⊗ I ) {( G ⊗ A )}^{- 1} {( {E}_{{R}^{′}} ⊗ I )}^{T} )}^{- 1} ( {E}_{{R}^{′}} ⊗ I ) {θ}^{*} \\ = - ( {G}^{- 1} {E}_{{R}^{′}}^{T} ⊗ {A}^{- 1} ) {( {E}_{{R}^{′}} {G}^{- 1} {E}_{{R}^{′}}^{T} ⊗ {A}^{- 1} )}^{- 1} \overline{{θ}^{*}} \\ = - ( {G}^{- 1} {E}_{{R}^{′}}^{T} ⊗ {A}^{- 1} ) ( {( {E}_{{R}^{′}} {G}^{- 1} {E}_{{R}^{′}}^{T} )}^{- 1} ⊗ A ) \overline{{θ}^{*}}\end{matrix} \qquad ( 27 )$$

$$\begin{matrix}Δ W = - {G}^{- 1} {E}_{{R}^{′}}^{T} ( {( {E}_{{R}^{′}} {G}^{- 1} {E}_{{R}^{′}}^{T} )}^{- 1} \overline{W} A ) {A}^{- 1} \\ = - {G}^{- 1} {{E}_{{R}^{′}}^{T} ( {E}_{{R}^{′}} {G}^{- 1} {E}_{{R}^{′}}^{T} )}^{- 1} Δ W\end{matrix}$$

Similarly, we derive the removal of C′ columns by defining removal matrix as E_{K}=I⊗E_{C′} and define W̅:=E_{C′}W∈ [symbol] ^{R×C′}. The complete weight update for multiple column removal becomes:

$$\begin{matrix}Δθ = - {F}^{- 1} {{E}_{K}^{T} ( {E}_{K} {F}^{- 1} {E}_{K}^{T} )}^{- 1} {E}_{K} {θ}^{*} \\ {= - {( G ⊗ A )}^{- 1} ( I ⊗ {E}_{{C}^{′}} ) )}^{T} {( ( I ⊗ {E}_{{C}^{′}} ) {( G ⊗ A )}^{- 1} {( I ⊗ {E}_{{C}^{′}} )}^{T} )}^{- 1} ( I ⊗ {E}_{{C}^{′}} ) {θ}^{*} \\ {= {( G ⊗ A )}^{- 1} ( I ⊗ {E}_{{C}^{′}} ) )}^{T} {( ( I ⊗ {E}_{{C}^{′}} ) {( G ⊗ A )}^{- 1} {( I ⊗ {E}_{{C}^{′}} )}^{T} )}^{- 1} ( I ⊗ {E}_{{C}^{′}} ) {θ}^{*} \\ = - ( {G}^{- 1} ⊗ {A}^{- 1} {E}_{{C}^{′}}^{T} ) {( G ⊗ {E}_{{C}^{′}} {A}^{- 1} {E}_{{C}^{′}}^{T} )}^{- 1} \overline{θ}\end{matrix} \qquad ( 28 )$$

$$\begin{matrix}Δ W = - {G}^{- 1} G {\overline{W} ( {E}_{{C}^{′}} {A}^{- 1} {E}_{{C}^{′}}^{T} )}^{- 1} ( {A}^{- 1} {E}_{{C}^{′}}^{T} ) \\ = - \overline{W} {( {E}_{{C}^{′}} {A}^{- 1} {E}_{{C}^{′}}^{T} )}^{- 1} ( {A}^{- 1} {E}_{{C}^{′}}^{T} )\end{matrix}$$

Pseudocode for additional processes is shown below.

Process 2 LLM-Surgeon (Structured)

```
Input: target size α
Input: initial weights θ₀
  For shot t in [1, 2, ..., T]
    Compute: approximate curvature G₁, A₁ from data (optionally also G₂, A₂)
    Compute: costs per row/column [symbol]    ᵣ, [symbol]    _{c} from G₁, A₁ , (G₂, A₂)
    Compute: threshold τ using [symbol]    ᵣ and [symbol]    _{c} given target size α
    Select: rows and columns to remove Q_{R}, Q_{c} based on τ
    Compute: weight update Δθ^{t-1} based on Q_{R}, Q_{c} and G₁, A₁ , (G₂, A₂)
    Update: remaining weights θ^{t} ← θ^{t-1} + Δθ^{t-1}
    Optionally: θ^{t} ← low-rank update(θ^{t})
  Output: compressed weights \hat{θ} = θ^{T}
```

In process 2, we describe how LLM Surgeon operates for structured pruning given a pruning target α and the initial weights θ₀. For T times, repeat the following steps. Compute the approximate curvature G₁, A₁ from data (and optionally also G₂, A₂). Then, compute the cost per row/column [symbol] ᵣ and [symbol] _{c} using G₁ and A₁ (and optionally G₂, A₂). Afterwards, compute the global threshold τ using [symbol] ᵣ and, [symbol] _{c} such that it meets the given target size of the current shot αₜ. Then, select rows and columns to remove Q_{R} and Q_{c} based on τ. Next, compute the weight update Δθ^{t-1} based on Q_{R}, Q_{c} and G₁, A₁ (and optionally G₂, A₂). Finally, update the remaining weights θ^{t}←θ^{t-1}+Δθ^{t-1}. Optionally, perform a low-rank update θ^{t}←low-rank update (θ^{t}) at the end. These steps are repeated T times at which the target compression rate α is reached. The compressed weights \hat{θ}=θ^{T} are then returned.

Process 3 LLM-Surgeon (semi-structured/unstructured)

```
Input: target size α
Input: initial weights θ₀
  For shot t in [1, 2, ..., T]
    Compute: approximate curvature G₁, A₁ from data (optionally also G₂, A₂)
    Compute: costs per row/column [symbol]   ₖ from G₁, A₁ , (G₂, A₂)
    Compute: threshold τ from [symbol]    ₖ and target size α (unstructured/semi-structured)
    Select: elements to remove Q based on τ (unstructured/semi-structured)
    Compute: weight update Δθ^{t-1} based on Q_{R}, Q_{c} and G₁, A₁ , (G₂, A₂)
    Update: remaining weights θ^{t} ← θ^{t-1} + Δθ^{t-1}
    Optionally: θ^{t} ← low-rank update(θ^{t})
  Output: compressed weights \hat{θ} = θ^{T}
```

In process 3, we describe how LLM Surgeon operates for semi-structured and unstructured pruning given a pruning target α and the initial weights θ₀. For T times, repeat the following steps. Compute the approximate curvature G₁, A₁ from data (and optionally also G₂, A₂). Then, compute the cost per element [symbol] ₖ using G₁ and A₁ (and optionally G₂, A₂). Afterwards, compute the global threshold τ using [symbol] ₖ such that it meets the given target size of the current shot αₜ. Then, select the elements to remove Q based on τ. Next, compute the weight update Δθ^{t-1} based on Q_{R}, Q_{c} and G₁, A₁ (and optionally G₂, A₂). Finally, update the remaining weights θ^{t}←θ^{t-1}+Δθ^{t-1}. Optionally, perform a low-rank update θ^{t}←low-rank update (θ^{t}) at the end. These steps are repeated T times at which the target compression rate α is reached. The compressed weights \hat{θ}=θ^{T} are then returned.

### APPENDIX B

### Dampening

In practice, we dampen the G and A matrices by adding a diagonal term G+λ_{G}I and A+λ_{A}I. In some implementations, values in the range [0.01, 0.1] multiplied by mean diagonal terms generally work well. We may use λ_{A}=0.01diag(A) to be consistent with prior work and allow for a fair comparison with baselines. Further, we may use λ_{G}=0.1diag(G) for structured implementations and λ_{G}=0.01diag(G) in semi-structured and unstructured implementations.

### APPENDIX C

### Extending Curvature Estimates

Instead of using a single Kronecker product, we can improve the approximation through a sum of multiple Kronecker factors:

$$F \approx \tilde{F} = {G}_{1} ⊗ {A}_{1} + {G}_{2} ⊗ {A}_{2} \qquad ( 30 )$$

Appendix C addresses the question of how one may computationally find such approximations and how to utilize them in the neural network pruning framework.

Nearest Kronecker product or sum of Kronecker products.

Instead of assuming independence of activations and derivatives following the classic KFAC technique, we may find the nearest Kronecker product approximation F≈\tilde{G}⊗Ã that is closest to the Fisher in terms of the Frobenius norm:

$${\tilde{G}}_{l} , {\tilde{A}}_{l} = {arg min}_{{G}_{l} , {A}_{l}} {‖ {F}_{l} - {G}_{l} ⊗ {A}_{l} ‖}_{F} \qquad ( 31 )$$

Finding the nearest sum of Kronecker factors can be rephrased as a classic eigenvalue problem of finding the nearest rank-1 matrix.

$${‖ F - \tilde{G} ⊗ \tilde{A} ‖}_{F} ≡ {‖ ℛ ( F ) - v e c ( \tilde{G} ) {vec ( \tilde{A} )}^{T} ‖}_{F} \qquad ( 32 )$$

Power method and deflation.

After considering the reshaping, we can use power iterations to solve equations 31 and 32 to find an initial G and A matrix and find the nearest Kronecker factors G₁, A₁=solve(F).

Find with Power Iterations: Deflation

$$\begin{matrix}{\tilde{G}}_{1} , {\tilde{A}}_{1} = solve ( F ) = {arg min}_{G , A} {‖ F - G ⊗ A ‖}_{F} & {\tilde{G}}_{r} , {\tilde{A}}_{r} = solve ( F - {\sum }_{{r}^{′} = 1}^{r - 1} ( {\tilde{G}}_{r ′} ⊗ {\tilde{A}}_{r ′} ) )\end{matrix}$$

A more extensive description of the power method solve(⋅) can be seen in process 4. At the start of process 4, we initialize power iterations as a vector with ones 1=[1 1 . . . 1]. After each shot, we can initialize the vector as the final estimate found during the previous shot.

```
Process 4 Kronecker power method. Finds \tilde{G}, Ã nearest Kronecker
product ||F − \tilde{G} ⊗ Ã||_{F}
Input: Initialize \tilde{g}⁰ = 1, ã⁰ = 1 (or using estimates of previous shot).
Input: Set iterations I (or I = 1 if using estimates from previous shot)
Output: \tilde{G}, Ã
  for iteration I in [1, 2, . . . , I] do
    Compute:
    ${\tilde{g}}^{i} = \frac{ℛ ( \tilde{F} ) {\tilde{a}}^{i - 1}}{{‖ ℛ ( \tilde{F} ) {\tilde{a}}^{i - 1} ‖}_{2}} , with ℛ ( \tilde{F} ) {\tilde{a}}^{i - 1} = \frac{1}{N} {\sum }_{n = 1}^{N} {a}_{n}^{T} {\tilde{A}}^{i - 1} {a}_{n} vec ( {g}_{n} {g}_{n}^{T} )$
    Compute:
    ${\tilde{a}}^{i} = \frac{{ℛ ( \tilde{F} )}^{T} {\tilde{g}}^{i}}{{‖ {ℛ ( \tilde{F} )}^{T} {\tilde{g}}^{i} ‖}_{2}} , with {ℛ ( \tilde{F} )}^{T} {\tilde{g}}^{i} = \frac{1}{N} {\sum }_{n = 1}^{N} {g}_{n}^{T} {\tilde{G}}^{i} {g}_{n} vec ( {a}_{n} {a}_{n}^{T} )$
    Compute: σⁱ = ||ãⁱ||₂
  end for
  Return: \tilde{G} = \sqrt{σⁱ}mat(\tilde{g}), Ã = \sqrt{σⁱ}mat(ã)
```

For the Kronecker factor approximations \tilde{F}≈Σᵣ₌₁^{R}^{_{K}}Gᵢ⊗Aᵢ, larger R_{K} yields better approximations to the true Fisher F for larger R_{K}, as measured by the root mean squared error (RMSE).

Extended curvature approximations.

For classic KFAC with IAD or R_{K}=1 nearest Kronecker approximations of the form \tilde{F}=G⊗A, the inverse simply becomes (G⊗A)⁻¹=G⁻¹⊗A⁻¹. Unfortunately, we cannot use this inverse identity for sum of Kronecker factors, which is why we fall back on eigendecompositions G=E₁S₁E₁^{T}, and A=E₂S₂E₂^{T} allowing us to decompose the Fisher into:

$$\tilde{F} = {K}_{1} {S}_{1} {K}_{1}^{T} ⊗ {K}_{2} {S}_{2} {K}_{2}^{T} = ( {K}_{1} ⊗ {K}_{2} ) ( I ⊗ I + {S}_{1} ⊗ {S}_{2} ) ( {K}_{1}^{T} ⊗ {K}_{2}^{T} ) \qquad ( 33 )$$

Because K₁ and K₂ are orthogonal and S₁ and S₂ diagonal, the inverse Fisher becomes:

$${\tilde{F}}^{- 1} = ( {K}_{1} ⊗ {K}_{2} ) {( I ⊗ I + {S}_{1} ⊗ {S}_{2} )}^{- 1} ( {K}_{1}^{T} ⊗ {K}_{2}^{T} ) \qquad ( 34 )$$

In the context of neural network training, the problem becomes more difficult because we want to incrementally construct estimates \tilde{G}ᵢ and Ãᵢ from individual samples a_{l,n}, g_{l,n} that make up F, without having to simultaneously store more than a single or batch of input activations a_{l,n} or output gradients g_{l,n} in memory. A sum of multiple R_{K}>1 Kronecker factors will yield closer approximations, but also linearly increases a memory requirements with higher R_{K} and makes inverting F⁻¹ considerably more difficult.

Formulas to compute cost and weight updates.

For the sum of Kronecker factors, we find that the constrained optimization solution for costs Δ [symbol] in equation 7 and weight updates Δθ in equation 8 becomes the following inner-product and matrix-vector product:

$${ℒ}_{k} = \frac{1}{2} 〈 \overline{{θ}^{*}} , U \overline{{θ}^{*}} 〉 = {( \overline{{θ}^{*}} )}^{T} U ( \overline{{θ}^{*}} ) ∈ ℝ \qquad ( 35 )$$

$$Δθ = {\tilde{F}}^{- 1} {E}_{K}^{T} u = {K}_{1} ( {\overline{K}}_{1}^{T} U {\overline{K}}_{2} ⌀ [ {11}^{T} + {s}_{1} {s}_{2}^{T} ] ) {K}_{2}^{T} ∈ {ℝ}^{R C} , \qquad ( 36 )$$

with the heart of it all a matrix U=[E_{K}F⁻¹E_{K}^{T}]⁻¹ that captures correlations between weights:

$$U = {[ {E}_{K} ( {K}_{1} ⊗ {K}_{2} ) {( I ⊗ I + {S}_{1} ⊗ {S}_{2} )}^{- 1} ( {K}_{1}^{T} ⊗ {K}_{2}^{T} ) {E}_{K}^{T} ]}^{- 1} , \qquad ( 37 )$$

where (I⊗I+S₁⊗S₎₂ is diagonal and the inverse can thus be computed element-wise. The remaining inverse is of size K×K, for K correlated weights.

Note on sum of Kronecker factors.

Appendix C is included to illustrate the applicability of the techniques of the present disclosure to applications other than neural network pruning.

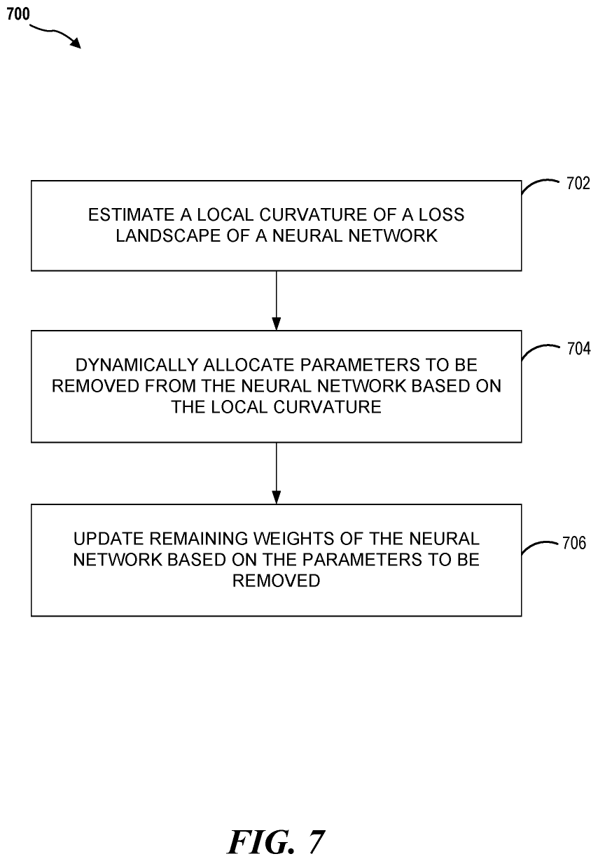

FIG. 7 is a flow diagram illustrating an example of a process 700 for pruning neural networks, in accordance with aspects of the present disclosure. As shown in FIG. 7, in some aspects, the process 700 may include estimating a local curvature of a loss landscape of a neural network (block 702). For example, the process may estimate the local curvature based on weight magnitudes or activation outer products obtained from forward passes of the neural network, and gradient outer products from backward passes of the neural network. The remaining weights may be updated based on a Kronecker-factored approximate curvature (KFAC). The remaining weights may be updated by assuming dependence of the elements of the neural network. In some aspects, the process may update the remaining weights by computing a single correlated weight update associated with removing all of the allocated parameters together.

In some aspects, the process 700 may include dynamically allocating parameters to be removed from the neural network based on the local curvature (block 704). For example, the process may iteratively estimate the local curvature and dynamically allocate the parameters to be removed.

In some aspects, the process 700 may include updating remaining weights of the neural network based on the parameters to be removed (block 706). For example, the process may iteratively dynamically allocate the parameters to be removed and update the remaining weights with a low-rank adaptation.

### EXAMPLE ASPECTS

Aspect 1: An apparatus, comprising: at least one memory; and at least one processor coupled to the at least one memory, the at least one processor configured to: estimate a local curvature of a loss landscape of a neural network; dynamically allocate parameters to be removed from the neural network based on the local curvature; and update remaining weights of the neural network based on the parameters to be removed.

Aspect 2: The apparatus of Aspect 1, in which the at least one processor is further configured to estimate the local curvature based on: weight magnitudes or activation outer products obtained from forward passes of the neural network, and gradient outer products from backward passes of the neural network.

Aspect 3: The apparatus of Aspect 1 or 2, in which the at least one processor is further configured to update the remaining weights based on a Kronecker-factored approximate curvature (KFAC).

Aspect 4: The apparatus of Aspect 1, 2 or 3, in which the at least one processor is further configured to update the remaining weights based on assuming dependence of the elements of the neural network.

Aspect 5: The apparatus of Aspect 1-4, in which the at least one processor is further configured to update the remaining weights by computing a single correlated weight update associated with removing all of the allocated parameters together.

Aspect 6: The apparatus of any of the preceding Aspects, in which the at least one processor is further configured to iteratively estimate the local curvature and dynamically allocate the parameters to be removed.

Aspect 7: The apparatus of any of the preceding Aspects, in which the at least one processor is further configured to iteratively dynamically allocate the parameters to be removed and update the remaining weights with a low-rank adaptation.

Aspect 8: A method of wireless communication, comprising: estimating a local curvature of a loss landscape of a neural network; dynamically allocating parameters to be removed from the neural network based on the local curvature; and updating remaining weights of the neural network based on the parameters to be removed.

Aspect 9: The method of Aspect 8, in which the estimating the local curvature is based on: weight magnitudes or activation outer products obtained from forward passes of the neural network, and gradient outer products from backward passes of the neural network.

Aspect 10: The method of Aspect 7-9, in which the updating remaining weights is based on a Kronecker-factored approximate curvature (KFAC).

Aspect 11: The method of Aspect 7-10, in which the updating the remaining weights is based on assuming dependence of the elements of the neural network.

Aspect 12: The method of Aspect 7-11, in which the updating the remaining weights further comprising computing a single correlated weight update associated with removing all of the allocated parameters together.

Aspect 13: The method of any of the Aspects 7-12, further comprising iteratively estimating the local curvature and dynamically allocate the parameters to be removed.

Aspect 14: The method of any of the Aspects 7-13, further comprising iteratively dynamically allocating the parameters to be removed and updating remaining weights with a low-rank adaptation.

Aspect 15: A non-transitory computer-readable medium having program code recorded thereon, the program code executed by a processor and comprising: program code to estimate a local curvature of a loss landscape of a neural network; program code to dynamically allocate parameters to be removed from the neural network based on the local curvature; and program code to update remaining weights of the neural network based on the parameters to be removed.

Aspect 16: The non-transitory computer-readable medium of Aspects 15, in which the program code to estimate a local curvature is based on: weight magnitudes or activation outer products obtained from forward passes of the neural network, and gradient outer products from backward passes of the neural network.

Aspect 17: The non-transitory computer-readable medium of Aspects 15 or 16, in which the program code to update the remaining weights is based on a Kronecker-factored approximate curvature (KFAC).

Aspect 18: The non-transitory computer-readable medium of Aspects 15-17, in which the program code to update the remaining weights is based on assuming dependence of the elements of the neural network.

Aspect 19: The non-transitory computer-readable medium of Aspects 15-18, in which the program code to update the remaining weights further comprising program code to compute a single correlated weight update associated with removing all of the allocated parameters together.

Aspect 20: The non-transitory computer-readable medium of any of the Aspects 15-19, in which the program code further comprises program code to iteratively estimate the local curvature and dynamically allocate the parameters to be removed.

Aspect 21: The non-transitory computer-readable medium of any of the Aspects 15-20, in which the program code further comprises program code to iteratively dynamically allocate the parameters to be removed and update the remaining weights with a low-rank adaptation.

Aspect 22: An apparatus for wireless communication, comprising: means for estimating a local curvature of a loss landscape of a neural network; means for dynamically allocating parameters to be removed from the neural network based on the local curvature; and means for updating remaining weights of the neural network based on the parameters to be removed.

Aspect 23: The apparatus for wireless communication of Aspects 22, in which the means for estimating the local curvature is based on: weight magnitudes or activation outer products obtained from forward passes of the neural network, and gradient outer products from backward passes of the neural network.

Aspect 24: The apparatus for wireless communication of Aspects 22 or 23, in which the means for updating the remaining weights is based on a Kronecker-factored approximate curvature (KFAC).

Aspect 25: The apparatus for wireless communication of Aspects 22-24, in which the means for updating the remaining weights is based on assuming dependence of the elements of the neural network.

Aspect 26: The apparatus for wireless communication of Aspects 22-25, in which the means for updating the remaining weights further comprises means for computing a single correlated weight update associated with removing all of the allocated parameters together.

Aspect 27: The apparatus for wireless communication of any of the Aspects 22-26, further comprising means for iteratively estimating the local curvature and dynamically allocate the parameters to be removed.

Aspect 28: The apparatus for wireless communication of any of the Aspects 22-27, further comprising means for iteratively dynamically allocating the parameters to be removed and updating the remaining weights with a low-rank adaptation.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
at least one processor coupled to the at least one memory, the at least one processor configured to:
estimate a local curvature of a loss landscape of a neural network;
dynamically allocate parameters to be removed from the neural network based on the local curvature; and
update remaining weights of the neural network based on the parameters to be removed.

2. The apparatus of claim 1, in which the at least one processor is further configured to estimate the local curvature based on:
weight magnitudes or activation outer products obtained from forward passes of the neural network, and
gradient outer products from backward passes of the neural network.

3. The apparatus of claim 1, in which the at least one processor is further configured to update the remaining weights based on a Kronecker-factored approximate curvature (KFAC).

4. The apparatus of claim 1, in which the at least one processor is further configured to update the remaining weights based on assuming dependence of elements of the neural network.

5. The apparatus of claim 1, in which the at least one processor is further configured to update the remaining weights by computing a single correlated weight update associated with removing all of the allocated parameters together.

6. The apparatus of claim 1, in which the at least one processor is further configured to iteratively estimate the local curvature and dynamically allocate the parameters to be removed.

7. The apparatus of claim 1, in which the at least one processor is further configured to iteratively dynamically allocate the parameters to be removed and update the remaining weights with a low-rank adaptation.

8. A processor-implement method, comprising:
estimating a local curvature of a loss landscape of a neural network;
dynamically allocating parameters to be removed from the neural network based on the local curvature; and
updating remaining weights of the neural network based on the parameters to be removed.

9. The method of claim 8, in which the estimating the local curvature is based on:
weight magnitudes or activation outer products obtained from forward passes of the neural network, and
gradient outer products from backward passes of the neural network.

10. The method of claim 8, in which the updating the remaining weights is based on a Kronecker-factored approximate curvature (KFAC).

11. The method of claim 8, in which the updating the remaining weights is based on assuming dependence of elements of the neural network.

12. The method of claim 8, in which the updating the remaining weights further comprising computing a single correlated weight update associated with removing all of the allocated parameters together.

13. The method of claim 8, further comprising iteratively estimating the local curvature and dynamically allocate the parameters to be removed.

14. The method of claim 8, further comprising iteratively dynamically allocating the parameters to be removed and updating the remaining weights with a low-rank adaptation.

15. A non-transitory computer-readable medium having program code recorded thereon, the program code executed by a processor and comprising:
program code to estimate a local curvature of a loss landscape of a neural network;
program code to dynamically allocate parameters to be removed from the neural network based on the local curvature; and
program code to update remaining weights of the neural network based on the parameters to be removed.

16. The non-transitory computer-readable medium of claim 15, in which the program code to estimate the local curvature is based on:
weight magnitudes or activation outer products obtained from forward passes of the neural network, and
gradient outer products from backward passes of the neural network.

17. The non-transitory computer-readable medium of claim 15, in which the program code to update the remaining weights is based on a Kronecker-factored approximate curvature (KFAC).

18. The non-transitory computer-readable medium of claim 15, in which the program code to update the remaining weights is based on assuming dependence of elements of the neural network.

19. The non-transitory computer-readable medium of claim 15, in which the program code to update the remaining weights further comprises program code to compute a single correlated weight update associated with removing all of the allocated parameters together.

20. The non-transitory computer-readable medium of claim 15, in which the program code further comprises program code to iteratively estimate the local curvature and dynamically allocate the parameters to be removed.

21. The non-transitory computer-readable medium of claim 15, in which the program code further comprises program code to iteratively dynamically allocate the parameters to be removed and update the remaining weights with a low-rank adaptation.

22. An apparatus for wireless communication, comprising:
means for estimating a local curvature of a loss landscape of a neural network;
means for dynamically allocating parameters to be removed from the neural network based on the local curvature; and
means for updating remaining weights of the neural network based on parameters to be removed.

23. The apparatus for wireless communication of claim 22, in which the means for estimating the local curvature is based on:
weight magnitudes or activation outer products obtained from forward passes of the neural network, and
gradient outer products from backward passes of the neural network.

24. The apparatus for wireless communication of claim 22, in which the means for updating remaining weights is based on a Kronecker-factored approximate curvature (KFAC).

25. The apparatus for wireless communication of claim 22, in which the means for updating remaining weights is based on assuming dependence of elements of the neural network.

26. The apparatus for wireless communication of claim 22, in which the means for updating remaining weights further comprises means for computing a single correlated weight update associated with removing all allocated parameters together.

27. The apparatus for wireless communication of claim 22, further comprising means for iteratively estimating the local curvature and dynamically allocating parameters to be removed.

28. The apparatus for wireless communication of claim 22, further comprising means for iteratively dynamically allocating parameters to be removed and updating remaining weights with a low-rank adaptation.
